(19) United States
(12) Patent Application Publication
(10) Pub. No.: US 2006/0078745 A1
(43) Pub. Date: Apr. 13, 2006

(54) Formable composite films of plastic and composite elements of plastic coated with soft touch coating, and the production thereof

(75) Inventors: Heinz Pudleiner, Krefeld (DE); Torsten Pohl, Leverkusen (DE); Uwe Klippert, Burscheid (DE); Klaus Meyer, Dormagen (DE); Bernd Post, Moers (DE); Armin Berger, Langenfeld (DE); Thorsten Rische, Unna (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/247,354

(22) Filed: Oct. 11, 2005

(30) Foreign Application Priority Data
Oct. 12, 2004 (DE) 102004049592.0

(51) Int. Cl. B32B 27/40; B29C 45/14

(52) U.S. Cl. 428/423.1; 264/259

(57) ABSTRACT

The present invention relates to composite plastic moldings containing A) a thermoplastically formable, heat-resistant composite film having A1) a carrier film of a thermoplastic resin and A2) a layer of a heat-resistant soft touch coating on one side of the carrier film (A1) and B) a thermoplastic layer on the side of the carrier film (A1) facing away from the soft touch coating, wherein the soft touch coating (A2) is obtained from a composition containing i) polyurethanes and/or polyurethane-ureas which are free from hydroxyl and/or amine groups, ii) ionically modified polyurethanes and/or polyurethane-ureas which contain hydroxyl and/or amine groups, iii) at least one crosslinking agent, iv) optionally film-forming resins other than A1) or A2), and v) optionally additives. The present invention also relates to a process for the production of these composite moldings and their use in telecommunications equipment and in vehicle, ship and aircraft construction.

### BACKGROUND OF THE INVENTION

1. Field of the Invention

The invention relates to composite moldings of thermoplastically formable composite films having a layer of a soft touch coating and a carrier film, in particular a polycarbonate film, and a layer of a back-injected, back-cast or back-pressed thermoplastic, and to a process for the production of the composite elements and composite films and their use in telecommunications equipment and in vehicle, ship and aircraft construction.

2. Description of the Prior Art

Elements of plastic coated with soft touch coatings and processes for the production thereof are generally known. As a rule, a composite element of a soft touch layer and the component of plastic is produced by means of subsequent coating of the component. In automobile construction in particular, this is the preferred procedure if components of large area or those of complex geometry are to be produced. Nevertheless, this subsequent application of the soft touch layer requires a large number of separate working steps, some of which have to be performed manually and cannot be automated. Moreover, certain part areas of the component can be coated with the soft touch layer only with a very high outlay. Furthermore, a not inconsiderable loss of the soft feel coating is to be expected in the coating of three-dimensionally formed articles due to the so-called overspray. The proportion of three-dimensional components coated without defects is also significantly lower than in the case of the industrially simpler coating of two-dimensional films.

In order to arrive at an efficient and inexpensive process which saves raw materials, attempts have been made to back-inject or back-press composite films with a material of plastic directly in one working operation. However, in this case the soft touch layer is regularly affected because of the high processing temperatures which occur. For example, points or areas of shine are observed. Various solutions are proposed so that the sensitive layers are not damaged during back-injecting.

EP-B 529 094 describes moldings of a substrate and a cover film, wherein the cover film comprises a resin composition (coating) and a foamed layer. The resin composition gives the cover film a soft handle and contains a urethane resin, iso-cyanate, curing agent and elastic beads of plastic and/or particles of porous inorganic material. The special beads and/or articles having an oil absorption of more than 50 ml/100 g impart the soft touch feeling.

An object of the present invention is to provide composite moldings of plastic having a soft touch surface which are easy to produce and the soft touch surface of which is not affected during forming and back-injecting with plastic.

This object has been achieved with the composite moldings according to the invention and the production thereof.

### SUMMARY OF THE INVENTION

The present invention relates to composite plastic moldings containing
A) a thermoplastically formable, heat-resistant composite film having
   A1) a carrier film of a thermoplastic resin and
   A2) a layer of a heat-resistant soft touch coating on one side of the carrier film (A1) and
B) a thermoplastic layer on the side of the carrier film (A1) facing away from the soft touch coating,
   wherein the soft touch coating (A2) is obtained from a composition containing
i) polyurethanes and/or polyurethane-ureas which are free from hydroxyl and/or amine groups,
ii) ionically modified polyurethanes and/or polyurethane-ureas which contain hydroxyl and/or amine groups,
iii) at least one crosslinking agent,
iv) optionally film-forming resins other than A1) or A2), and
v) optionally additives.

The present invention also relates to a process for the production of the composite moldings according to the invention by
I) introducing a thermoplastically formable, heat-resistant composite film (A) of a carrier film (A1) of a thermoplastic and a coating (A2) of a soft touch coating on one side of the carrier film (A1) into a mold and
II) back-injecting, back-pressing, back-casting or back-foaming composite film A) with a thermoplastic resin on the side facing away from the soft touch coating,
   wherein the soft touch coating is obtained from a composition containing
i) polyurethanes and/or polyurethane-ureas which are free from hydroxyl and/or amine groups,
ii) ionically modified polyurethanes and/or polyurethane-ureas which contain hydroxyl- and/or amine groups,
iii) at least one crosslinking agent,
iv) optionally film-forming resins and
v) optionally additives.

### DETAILED DESCRIPTION OF THE INVENTION

The soft touch coatings employed according to the invention contain no porous inorganic fillers in order to generate the desired soft handle, and can easily be formed.

Films of polycarbonate and blends of polycarbonate and other plastics are preferably employed. The soft touch layer adheres very well to the carrier film.

Elastifying layers of adhesive or foam are not required. The adhesion of the soft touch layer to the carrier film and the extensibility of the soft touch layer are sufficient to withstand the forming step undamaged, without cracking or white fracture.

The back-injecting of the optionally printed and formed carrier film coated with soft touch coating is carried out with thermoplastics. It can even be carried out with polycarbonate at a material temperature of approx. 300° C. The soft touch layer is retained undamaged during this operation. Shiny areas which would indicate that the soft touch layer is damaged cannot be found.

The composite films employed for the composite moldings according to the invention have a good adhesion, formability, extensibility, visual properties and haptic properties and show no cracking during forming. The coating is also suitable for clear coating uses.

The composite film employed according to the invention has a soft touch layer on one side, at least in part areas, which can be formed to give three-dimensional components without cracking or so-called “white fracture”.

The soft touch layer has adequate adhesion to the carrier film and does not become detached from the carrier film during shaping.

The composite elements according to the invention are preferably employed in telecommunications equipment and in vehicle, aircraft and ship construction.

The process according to the invention is distinguished in that the composite film of the soft touch layer and the carrier film, which can optionally be printed, is formed to give a three-dimensional molding. This molding is laid in a mold, the soft touch layer lying against the wall of the mold, and back-injected, back-cast or back-pressed on the reverse with a thermoplastic. The process can be carried out in several separate steps or in one process step. In general, the initially formed composite film is laid in a mold and then fixed, before it is back-injected. Fixing is conventionally effected by electrostatic charging, needles, clips, tenters, point-wise gluing or by means of suction. The molding can also be back-foamed.

The composite moldings according to the invention can typically be formed and thermoformed by the vacuum process, the compressed air process and the thermo- or hydroforming process. However, the preferred process is the high pressure forming process.

Surprisingly, combinations of ionically modified, hydroxy- and/or amine-functional polyurethanes and/or -ureas, polyurethanes and/or -ureas which are free from hydroxyl and/or amine groups and crosslinking agents fulfil the profile of requirements for the soft touch coating and for the production of composite moldings by means of the corresponding composite films.

The soft touch coating compositions employed according to the invention contain
I) polyurethanes and/or polyurethane-ureas which are free from hydroxyl and/or amine groups,
II) ionically modified polyurethanes and/or polyurethane-ureas containing hydroxyl and/or amine groups,
(III) at least one crosslinking agent,
(IV) optionally further film-forming resins,
(V) optionally coating additives.

The non-functional compounds (I) and the functional crosslinkable compounds (II) are obtainable from the following components:
(1) polyisocyanates,
(2) polymeric polyols having number average molecular weights of 200 to 8,000 g/mol,
(3) low molecular weight compounds having number average molecular weights 62 to 400, which have a total of two or more hydroxyl and/or amino groups,
(4) compounds which have one hydroxyl or amino group (chain terminators),
(5) isocyanate-reactive, ionic or potential ionic hydrophilic compounds, and
(6) isocyanate-reactive, nonionic hydrophilic compounds.

The soft feel coatings (soft touch coatings) can also be employed in the form of foamed soft feel coatings. In this context, in the case of aqueous, solvent-containing or also solvent-free soft feel formulations, a foam structure which is distinguished by very good haptic properties and very good scratch resistance can be generated by mechanical foaming or corresponding processing conditions. Such coatings can be formed and processed to composite moldings without damage, i.e. without white fracture or loss of adhesion and without a change in the haptic properties and visual properties.

Suitable polyisocyanates (1) include the aromatic, araliphatic, aliphatic or cycloaliphatic polyisocyanates having an NCO functionality of preferably ≧2, which can also have iminooxadiazinedione, isocyanurate, uretdione, urethane, allophanate, biuret, urea, oxadiazinetrione, oxazolidinone, acylurea and/or carbodiimide groups, and are known in the art. The polyisocyanates can be employed individually or in any desired mixtures with one another.

Examples of suitable polyisocyanates include butylene-diisocyanate, hexamethylene-diisocyanate (HDI), isophorone-diisocyanate (IPDI), 2,2,4- and/or 2,4,4-trimethylhexamethylene-diisocyanate, the isomeric bis(4,4′-isocyanatocyclohexyl)methanes or mixtures thereof of any desired isomer content, isocyanatomethyl-1,8-octane-diisocyanate, 1,4-cyclohexylene-diisocyanate, 1,4-phenylene-diisocyanate, 2,4- and/or 2,6-toluylene-diisocyanate, 1,5-naphthylene-diisocyanate, 2,4′- or 4,4′-diphenylmethane-diisocyanate, triphenylmethane-4,4′,4″-triisocyanate or adducts prepared from these diisocyanates, having a uretdione, isocyanurate, urethane, allophanate, biuret, iminooxadiazinedione and/or oxadiazinetrione structure and having more than 2 NCO groups, such as those described in J. Prakt. Chem. 336 (1994) p. 185-200.

4-isocyanatomethyl-1,8-octane-diisocyanate (nonane-triisocyanate) e.g. is an example of a non-modified polyisocyanate having more than 2 NCO groups per molecule.

The polyisocyanates are preferably polyisocyanates or polyisocyanate mixtures having exclusively aliphatically and/or cycloaliphatically bound isocyanate groups.

Hexamethylene-diisocyanate, isophorone-diisocyanate, the isomeric bis(4,4′-isocyanatocyclohexyl)methane and mixtures thereof are particularly preferred.

Suitable polyols mentioned under (2) preferably have a number-average OH functionality of at least 1.8 to 4, a number-average molecular weight range from 200 to 8,000 and an OH functionality of 2 to 3. Polyols having number-average molecular weight ranges from 200 to 3,000 are particularly preferred.

Polyester polyols which can be employed as compounds (2) preferably have a number-average molecular weight of 400 to 6,000, more preferably 600 to 3,000. Their hydroxyl number is preferably 22 to 400, more preferably 50 to 200 and most preferably 80 to 160 mg KOH/g. They have a number-average OH functionality of 1.5 to 6, preferably 1.8 to 3 and particularly preferably 2.

Suitable compounds include the known polycondensates of di- and optionally poly(tri, tetra)ols and di- and optionally poly(tri, tetra)carboxylic acids or hydroxycarboxylic acids or lactones. Instead of the free polycarboxylic acids, it is also possible to use the corresponding polycarboxylic acid anhydrides or corresponding polycarboxylic acid esters of lower alcohols for the preparation of the polyesters. Examples of suitable diols include ethylene glycol, butylene glycol, diethylene glycol, triethylene glycol, polyalkylene glycols (such as polyethylene glycol), propanediol, butane-1,4-diol, hexane-1,6-diol, neopentylglycol or hydroxypivalic acid neopentylglycol ester; the last three compounds mentioned are preferred. As polyols which are optionally co-employed there may be mentioned here, for example, trimethylolpropane, glycerol, erythritol, pentaerythritol, trimethylolbenzene or tris-hydroxyethyl isocyanurate.

Suitable dicarboxylic acids include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachloro-phthalic acid, maleic acid, fumaric acid, itaconic acid, malonic acid, suberic acid, 2-methyl-succinic acid, 3,3-diethylglutaric acid and 2,2-dimethylsuccinic acid. Anhydrides of these acids can also be used, if they exist. For the purposes of the present invention, the anhydrides are consequently included under the term “acid”. Mono-carboxylic acids, such as benzoic acid and hexanecarboxylic acid, can also be used provided that the average functionality of the polyol is higher than 2. Saturated aliphatic or aromatic acids are preferred, such as adipic acid or isophthalic acid. Trimellitic acid may be may optionally be co-used in smaller amounts.

Hydroxycarboxylic acids which can be used as reaction participants in the preparation of a polyester polyol with terminal hydroxyl groups include hydroxy-caproic acid, hydroxybutyric acid, hydroxydecanoic acid or hydroxystearic acid. Lactones which can be used include caprolactone or butyrolactone.

The compounds of component (2) can also contain at least a proportion of primary or secondary amino groups as NCO-reactive groups.

Suitable compounds (2) include polycarbonates having a number-average molecular weight from 400 to 6,000, preferably 600 to 3,000, and containing hydroxyl groups, which are obtainable e.g. by reaction of carbonic acid derivatives, e.g. diphenyl carbonate, dimethyl carbonate or phosgene, with polyols, preferably diols. Suitable diols include ethylene glycol, 1,2- and 1,3-propanediol, 1,3- and 1,4-butanediol, 1,6-hexanediol, 1,8-octanediol, neopentylglycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A, and also lactone-modified diols. The diol component preferably contains 40 to 100 wt. % of hexanediol, preferably 1,6-hexanediol and/or hexanediol derivatives, preferably those which contain ether or ester groups in addition to terminal OH groups. Example include products which have been obtained by reaction of 1 mole of hexanediol with at least 1 mole, preferably 1 to 2 moles, of caprolactone or by etherification of hexanediol with itself to give di- or trihexylene glycol. Polyether-polycarbonate diols can also be employed. The hydroxypolycarbonates should be substantially linear. However, they can optionally be slightly branched by incorporation of polyfunctional components, in particular low molecular weight polyols. Polyols which are suitable for this include glycerol, trimethylolpropane, hexane-1,2,6-triol, butane-1,2,4-triol, trimethylolpropane, pentaerythritol, chinitol, mannitol, sorbitol, methyl glycoside or 1,3,4,6-dianhydrohexitols.

The hydroxypolycarbonates are preferably linear, but can optionally be branched by incorporation of polyfunctional components, in particular low molecular weight polyols. Polyols which are suitable for this include glycerol, trimethylol-propane, hexane-1,2,6-triol, butane-1,2,4-triol, trimethylolpropane, pentaerythritol, chinitol, mannitol and sorbitol or methyl glycoside and 1,3,4,6-dianhydrohexitols.

Suitable polyether polyols (2) include the polytetramethylene glycol polyethers which are known per se in polyurethane chemistry and which can be prepared e.g. via polymerization of tetrahydrofuran by cationic ring-opening.

Also suitable are polyethers, such as the polyols prepared by reacting starter molecules with styrene oxide, ethylene oxide, propylene oxide, butylene oxides or epichlorohydrin, in particular of propylene oxide.

The use of polyester polyols and/or polycarbonate polyols is preferred.

As a rule, the low molecular weight polyols (3) employed for building up the polyurethane resins have the effect of stiffening or branching the polymer chain. The molecular weight is preferably between 62 and 200. Suitable polyols can contain aliphatic, alicyclic or aromatic groups. Examples include the low molecular weight polyols having up to about 12 carbon atoms per molecule, such as ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, hydroquinone dihydroxyethyl ether, bisphenol A (2,2-bis(4-hydroxyphenyl)propane), hydrogenated bisphenol A (2,2-bis(4-hydroxycyclohexyl)propane) and mixtures thereof, trimethylolpropane, glycerol or pentaerythritol. Ester diols, such as δ-hydroxybutyl-ε-hydroxy-caproic acid esters, ω-hydroxyhexyl-γ-hydroxybutyric acid esters, adipic acid (β-hydroxyethyl) ester or terephthalic acid bis(β-hydroxyethyl) ester, can also be used.

Di- or polyamines and hydrazides can also be employed as compound (3). Examples include ethylenediamine, 1,2- and 1,3-diaminopropane, 1,4-diaminobutane, 1,6-diaminohexane, isophoronediamine, an isomer mixture of 2,2,4- and 2,4,4-trimethylhexamethylenediamine, 2-methylpentamethylenediamine, diethylenetriamine, 1,3- and 1,4-xylylenediamine, α,α,α′,α′-tetramethyl-1,3- and -1,4-xylylenediamine and 4,4-diaminodicyclohexylmethane, dimethylethylenediamine, hydrazine or adipic acid dihydrazide.

Compounds which contain active hydrogen having different reactivity to NCO groups are also suitable as compound (3). Examples include compounds, which also contain secondary amino groups in addition to a primary amino group, or also contain OH groups in addition to an amino group (primary or secondary). Examples of these primary/secondary amines include 3-amino-1-methylamino-propane, 3-amino-1-ethylaminopropane, 3-amino-1-cyclohexylaminopropane or 3-amino-1-methylaminobutane; and alkanolamines, such as N-aminoethylethanolamine, ethanolamine, 3-aminopropanol, neopentanolamine and particularly preferably diethanolamine. When used to prepare component (I), they are employed as chain lengtheners, and when they are used to prepare component (II), they are employed as chain termination.

The polyurethane resin can also be prepared from compounds (4), which are chain terminators. These compounds are monofunctional compounds which are reactive with NCO groups, such as monoamines, in particular mono-secondary amines, or monoalcohols. Examples include ethanol, n-butanol, ethylene glycol monobutyl ether, 2-ethylhexanol, 1-octanol, 1-dodecanol, 1-hexadecanol, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine and substituted derivatives thereof, amide-amines based on diprimary amines and monocarboxylic acids, monoketimines of diprimary amines, e.g. primary/tertiary amines, such as N,N-dimethylaminopropylamine and the like.

Ionic or potential ionic hydrophilic compounds (5) include all compounds which contain at least one isocyanate-reactive group and at least one functionality, such as —COOY, —SO₃Y, —PO(OY)₂ (Y for example ═H, NH₄⁺, metal cation), —NR₂, —NR₃⁺ (R=H, alkyl, aryl), which enter into a pH-dependent dissociation equilibrium on interaction with aqueous media and can be negatively, positively or neutrally charged in this manner. Preferred isocyanate-reactive groups are hydroxyl or amino groups.

Suitable ionic or potential ionic hydrophilic compounds (5) include mono- and dihydroxycarboxylic acids, mono- and diaminocarboxylic acids, mono- and dihydroxysulfonic acids, mono- and diaminosulfonic acids, and mono- and dihydroxyphosphonic acids or mono- and diaminophosphonic acids and their salts. Examples include dimethylolpropionic acid, dimethylolbutyric acid, hydroxypivalic acid, N-(2-aminoethyl)-β-alanine, 2-(2-amino-ethylamino)-ethanesulfonic acid, ethylenediamine-propyl- or -butylsulfonic acid, 1,2- or 1,3-propylenediamine-β-ethylsulfonic acid, malic acid, citric acid, glycolic acid, lactic acid, glycine, alanine, taurine, lysine, 3,5-diaminobenzoic acid, an addition product of IPDI and acrylic acid (EP-A 0 916 647, Example 1) and alkali metal and/or ammonium salts thereof; the adduct of sodium bisulfite on but-2-ene-1,4-diol, polyether-sulfonate, the propoxylated adduct of 2-butenediol and NaHSO₃, e.g. described in DE-A 2 446 440 (page 5-9. formula I-III) and compounds which contain as the hydrophilic structural component units, e.g. amine-based, which can be converted into cationic groups, such as N-methyl-diethanolamine. Cyclohexyl-aminopropanesulfonic acid (CAPS), described e.g. in WO-A 01/88006, can also be used as the compound (5).

Preferred ionic or potential ionic compounds (5) are those which have carboxyl or carboxylate and/or sulfonate groups and/or ammonium groups. Particularly preferred ionic compounds (5) are those which contain carboxyl and/or sulfonate groups as ionic or potential ionic groups, such as the salts of N-(2-aminoethyl)-β-alanine, 2-(2-amino-ethylamino)-ethanesulfonic acid or the addition product of IPDI and acrylic acid (EP-A 0 916 647, Example 1) and dimethylolpropionic acid.

Preferred ionic or potential ionic compounds (5) are those which have carboxyl and/or carboxylate groups. Particularly preferred ionic compounds (5) are dihydroxycarboxylic acids, especially α,α-dimethylolalkanoic acids, such as 2,2-dimethylolacetic acid, 2,2-dimethylolpropionic acid, 2,2-dimethylolbutyric acid, 2,2-dimethylolpentanoic acid or dihydroxysuccinic acid.

Suitable nonionic hydrophilic compounds (6) include polyoxyalkylene ethers which contain at least one hydroxyl or amino group. These polyethers have a content of 30 wt. % to 100 wt. % of ethylene oxide units.

Nonionic hydrophilic compounds include monofunctional polyalkylene oxide polyether alcohols containing an average of 5 to 70, preferably 7 to 55 ethylene oxide units per molecule, such as those prepared in known manner by the alkoxylation of suitable starter molecules (e.g. in Ullmanns Encyclopädie der technischen Chemie, 4th edition, volume 19, Verlag Chemie, Weinheim p. 31-38).

Suitable starter molecules include saturated monoalcohols, such as methanol, ethanol, n-propanol, isopropanol, n-butanol, isobutanol, sec-butanol, the isomeric pentanols, hexanols, octanols and nonanols, n-decanol, n-dodecanol, n-tetra-decanol, n-hexadecanol, n-octadecanol, cyclohexanol, the isomeric methyl-cyclohexanols or hydroxymethylcyclohexane, 3-ethyl-3-hydroxy-methyloxetane or tetrahydrofurfuryl alcohol, diethylene glycol monoalkyl ethers (such as diethylene glycol monobutyl ether), unsaturated alcohols (such as allyl alcohol, 1,1-dimethylallyl alcohol or oleyl alcohol), aromatic alcohols (such as phenol, the isomeric cresols or methoxyphenols), araliphatic alcohols (such as benzyl alcohol, anisyl alcohol or cinnamyl alcohol), secondary monoamines (such as dimethyl-amine, diethylamine, dipropylamine, diisopropylamine, dibutylamine, bis-(2-ethylhexyl)-amine, N-methyl- and N-ethylcyclohexylamine or dicyclo-hexylamine), and heterocyclic secondary amines (such as morpholine, pyrrolidine, piperidine or 1H-pyrazole). Preferred starter molecules are saturated monoalcohols, especially diethylene glycol monobutyl ether.

Alkylene oxides which are suitable for the alkoxylation reaction include ethylene oxide and propylene oxide, which can be employed in the alkoxylation reaction in any desired sequence or in admixture.

The polyalkylene oxide polyether alcohols are either pure polyethylene oxide polyethers or mixed polyalkylene oxide polyethers, the alkylene oxide units of which contain ethylene oxide units to the extent of at least 30 mol %, preferably to the extent of at least 40 mol %. Preferred nonionic compounds are monofunctional mixed polyalkylene oxide polyethers, which contain at least 40 mol % of ethylene oxide units and not more than 60 mol % of propylene oxide units.

A combination of ionic and nonionic hydrophilic agents (5) and (6) are preferably used for component (I). Combinations of nonionic and anionic hydrophilizing agents are particularly preferred.

Preferably, 5 to 45 wt. % component (1), 50 to 90 wt. % component (2), 1 to 30 wt. % of the total of compounds (3) and (4), 0 to 12 wt. % component (5) and 0 to 15 wt. % component (6) are employed, the total of (5) and (6) being 0.1 to 27 wt. % and the total of all the components adding up to 100 wt. %.

More preferably, 10 to 40 wt. % component (1), 60 to 85 wt. % component (2), 1 to 25 wt. % of the total of compounds (3) and (4), 0 to 10 wt. % component (5) and 0 to 10 wt. % component (6) are employed, the total of (5) and (6) being 0.1 to 20 wt. % and the total of all the components adding up to 100 wt. %.

Most preferably, 15 to 40 wt. % component (1), 60 to 82 wt. % component (2), 1 to 20 wt. % of the total of compounds (3) and (4), 0 to 8 wt. % component (5) and 0 to 10 wt. % component (6) are employed, the total of (5) and (6) being 0.1 to 18 wt. % and the total of all the components adding up to 100 wt. %.

Component (II) preferably contains only ionic hydrophilic compounds (5) to provide hydrophilicity.

The crosslinkable components (II) can be prepared by conventional processes known in the art. They contain carboxylic acid and/or sulfonic acid groups, preferably carboxylic acid groups, at least a proportion of which can be neutralized, as hydrophilic groups. Water-dilutable polyurethanes prepared from the following structural components are particularly suitable:
5-50 wt. %, preferably 8-30 wt. % polyisocyanates (1),
25-90 wt. %, preferably 30-85 wt. % of at least one polymeric polyol having a number-average molecular weight of 200 to 8,000 g/mol (2),
0-20 wt. %, preferably 1-15 wt. % of at least one low molecular weight compound of molecular weight 62-200 containing two or more hydroxyl and/or amino groups (3),
0-10 wt. %, preferably 0 wt. % of at least one compound (4) which is mono-functional with respect to the reaction with NCO groups or contains active hydrogens of different reactivity, these units in each case being in terminal positions of the polymer containing urethane groups,
1-10 wt. %, preferably 2-8 wt. % of at least one compound (5) which contains at least two groups which are reactive towards isocyanate groups and at least one group which is capable of anion formation,
0-15 wt. % of isocyanate-reactive, nonionic hydrophilic compounds (6),
   wherein the total of components (1) to (6) adds up to 100%.

The coating compositions contain components (I) which are employed in the form of their aqueous dispersions. The process for the preparation of the aqueous dispersions (I) can be carried out in one or more stages in a homogeneous or, in the case of the multi-stage reaction, partly in a disperse phase. When the polyaddition of (1) to (6) has been completely or partly carried out, a dispersing, emulsifying or dissolving step takes place. Thereafter, a further polyaddition or modification in a disperse phase is optionally carried out.

For the preparation of the aqueous PU dispersions (I), all the processes known from the prior art, such as the prepolymer mixing process, acetone process or melt dispersing process, can be used. The PU dispersion (I) is preferably prepared by the acetone process.

For the preparation of the PU dispersion (I) by the acetone process, components (2) to (6), which should not contain primary or secondary amino groups, and the polyisocyanate component (1) for the preparation of an isocyanate-functional polyurethane prepolymer are initially introduced into the reaction vessel in their entirety or in part, and optionally diluted with a solvent which is water-miscible but inert towards isocyanate groups and heated up to temperatures in the range from 50 to 120° C. The catalysts known in polyurethane chemistry can be employed to accelerate the isocyanate addition reaction. Dibutyltin dilaurate is preferred.

Suitable solvents are the known aliphatic, ketone-functional solvents, such as acetone and butanone, which can be added not only at the start of the preparation but optionally also later in portions. Acetone and butanone are preferred.

Any of components (1) to (6) which optionally are not yet added at the start of the reaction are then metered in.

In the preparation of the polyurethane prepolymer, the equivalent ratio of isocyanate groups to groups which are reactive with isocyanate is 1.0 to 3.5, preferably 1.1 to 3.0, and more preferably 1.1 to 2.5.

The reaction of components (1) to (6) to give a prepolymer is partly or completely carried out, but preferably completely. Polyurethane prepolymers which contain free isocyanate groups are obtained in this way in substance or in solution.

After or during the preparation of the polyurethane prepolymers, the partial or complete salt formation of the groups having an anionic and/or cationic dispersing action takes place, if this has not yet been carried out in the starting molecules. In the case of anionic groups, bases, such as tertiary amines (e.g. trialkylamines having 1 to 12, preferably 1 to 6 C atoms in each alkyl radical), are employed. Examples include trimethylamine, triethylamine, methyldiethylamine, tripropylamine and diisopropylethylamine. The alkyl radicals can also contain, for example, hydroxyl groups, as in the case of the dialkylmonoalkanol-, alkyldialkanol- and trialkanolamines. Inorganic bases, such as ammonia or sodium hydroxide or potassium hydroxide, can optionally be employed as the neutralizing agent. Triethylamine, triethanolamine, dimethylethanolamine or diisopropylethylamine are preferred.

Preferably, between 50 and 100% of the anionic groups are present in neutralized form, more preferably between 70 and 100%. In the case of cationic groups, sulfuric acid dimethyl ester or succinic acid are employed. If only nonionic hydrophilic compounds (6) with ether groups are used, the neutralization step is omitted. The neutralization can also be carried out simultaneously with the dispersing, such that the dispersing water contains the neutralizing agent.

Thereafter, in a further step the prepolymer obtained is dissolved with the aid of aliphatic ketones, such as acetone or butanone, if this has not yet or has only partly happened.

Suitable NH₂— and/or NH-functional components are then reacted with the remaining isocyanate groups. This chain lengthening/termination here can be carried out either in a solvent before the dispersing, during the dispersing step or in water after the dispersing step. Preferably, the chain lengthening is carried out before dispersing the prepolymer in water.

If compounds (5) having NH₂ or NH groups are employed for the chain lengthening, the chain lengthening of the prepolymers is preferably carried out before the dispersing step.

The degree of chain lengthening, that is to say the ratio of equivalents of NCO-reactive groups of the compounds employed for the chain lengthening to free NCO groups of the prepolymer, is between 40 to 150%, preferably between 70 to 120%, and more preferably between 80 to 120%.

Aminic components (3), (4) and/or (5) can optionally be employed in the process individually or in mixtures, in water- or solvent-diluted form, and in any sequence of addition.

If water or organic solvents are co-used as a diluent, the diluent content is preferably 70 to 95 wt. %.

The preparation of PU dispersion (I) from the chain extended prepolymers is carried out after the chain lengthening. For this, the dissolved and chain-lengthened polyurethane polymer either is introduced into the dispersing water, optionally under severe shear forces, such as vigorous stirring, or the dispersing water is stirred into the prepolymer solutions. Preferably, water is added to the dissolved prepolymer.

The solvent still contained in the dispersions after the dispersing step is optionally then removed by distillation. Removal during the dispersing is also possible.

The dispersion can be adjusted to be very finely divided, depending on the degree of neutralization and content of ionic groups, so that it practically has the appearance of a solution, but very coarsely divided dispersions, which are also adequately stable, are also possible.

The solids content of PU dispersion (I) is between 25 to 65%, preferably 30 to 60%, and more preferably between 40 to 60%.

It is also possible to modify aqueous PU dispersions (I) with polyacrylates. For this, an emulsion polymerization of olefinically unsaturated monomers, e.g. esters of (meth)acrylic acid and alcohols having 1 to 18 carbon atoms, styrene, vinyl esters or butadiene, is carried out in these polyurethane dispersions.

The coating compositions contain components (II), which are either converted into the aqueous form during their preparation and thus are present as a dispersion or, alternatively are also present as a solution in a water-miscible solvent which is inert to isocyanate groups.

Crosslinkable components (II) can be prepared by the processes known in the prior art. They contain carboxylic acid and/or sulfonic acid groups, preferably carboxylic acid groups, at least a proportion of which can be neutralized, as hydrophilic groups.

The compounds (2) to (6) can also contain C═C double bonds, which can originate e.g. from long-chain aliphatic carboxylic acids or fatty alcohols. Functionalization with olefinic double bonds is also possible, for example, by incorporation of allylic groups, acrylic acid or methacrylic acid and the esters thereof.

The preparation of crosslinkable components (II) is conventionally carried out by a procedure in which an isocyanate-functional prepolymer is first prepared from compounds (1) to (6), and in a second reaction step an OH- and/or NH-functional polyurethane is obtained by reaction with compounds (3), (4) and (5) in a non-aqueous medium, as described e.g. in EP-A 0 355 682, p. 4, 1. 39-45. However, the preparation can also be carried out by a procedure in which the polyurethane resin containing OH and/or NH groups is formed directly by reaction of components (1) to (6) in a non-aqueous medium, as described e.g. in EP-A 0 427 028, p. 4,1,54-p. 5, 1.1.

Compounds (2), which are employed for building up the molecular weight of the prepolymer, can, but do not necessarily have to, be first subjected to a distillation step under reduced pressure. These compounds are preferably distilled continuously in a thin film evaporator at temperatures ≧150° C., preferably at 170 to 230° C., and more preferably at 180 to 220° C., under a reduced pressure of ≦10 mbar, preferably ≦2 mbar, and more preferably ≦0.5 mbar. Low molecular weight, non-reactive volatile contents are separated off under these conditions. Volatile contents of 0.2 to 15 wt. %, preferably 0.5 to 10 wt. %, and more preferably 1 to 6 wt. % are separated off during the distillation.

The preparation of the prepolymer is usually carried out at temperatures of 0° to 140° C., depending on the reactivity of the isocyanate employed. Components (1) and (2) are preferably employed at an NCO/OH equivalent ratio of 0.5 to 0.99/1, preferably 0.55 to 0.95/1 and more preferably 0.57 to 0.9/1.

To accelerate the urethanization reaction, suitable known catalysts for accelerating the NCO/OH reaction can be employed. Examples include tertiary amines, such as triethylamine or diazobicyclooctane; organotin compounds, such as dibutyltin oxide, dibutyltin dilaurate or tin bis(2-ethylhexanoate); or other organometallic compounds.

The prepolymer preparation is preferably carried out in the presence of solvents which are inert to isocyanate groups. Suitable solvents, which are compatible with water, include ethers, ketones and esters as well as N-methylpyrrolidone. The amount of this solvent preferably does not exceed 30 wt. % and more preferably is in the range from 10 to 25 wt. %, based on the total weight of polyurethane resin and solvent.

At least a proportion of the acid groups incorporated in the prepolymer are neutralized. This can take place during or also after the preparation of the prepolymer, but also during or after dispersing in water, by addition of suitable neutralizing agents (see previously described PU dispersion (I)). An example is dimethylethanolamine, which preferably serves as the neutralizing agent. The neutralizing agent is usually employed in a molar ratio to the acid groups of the prepolymer of 0.3:1 to 1.3:1, preferably 0.4:1 to 1:1.

The neutralization step is preferably carried out after the preparation of the prepolymer at temperatures of 0 to 80° C., preferably 40 to 80° C.

The hydroxy- and/or amino-functional polyurethane is then converted into an aqueous dispersion by addition of water or by introducing into water.

The resins of the PU polymers (II) have a number-average molecular weight Mn of 1,000 to 30,000, preferably 1,500 to 10,000; an acid number of 10 to 80, preferably 15 to 40 mg KOH/g; and an OH content of 0.5 to 6 wt. %, preferably 1.0 to 4 wt. %.

PU dispersions (I) and (II) can contain, as a further component (7), antioxidants, light stabilizers and/or other additives.

Light stabilizers and antioxidants (7) which can optionally be used include the additives which are known for polyurethanes and polyurethane dispersions and are described, for example, in “Lichtschutzmittel für Lacke” (A. Valet, Vincentz Verlag, Hanover, 1996) and “Stabilization of Polymeric Materials” (H. Zweifel, Springer Verlag, Berlin, 1997). The PU dispersions can also contain all the additives known for PU dispersions, such as emulsifiers, defoamers and thickeners, fillers, plasticizers, pigments, carbon black and silica sols and dispersions of aluminium, clay or asbestos.

The coating compositions can also contain crosslinking agents (III). Both one-component coating compositions and two-component coating compositions can be prepared, depending on the choice of the crosslinking agent. One-component coatings in the context of the present invention are understood as meaning coating compositions in which the binder component and crosslinking component can be stored together without a crosslinking action taking place to an extent which is noticeable or harmful for the later application. The crosslinking reaction takes place only on application, after activation of the crosslinking agent. This activation can be effected e.g. by an increase in temperature. Two-component coating compositions in the context of the present invention are understood as meaning coating compositions in which the binder component and crosslinking component must be stored in separate vessels because of their high reactivity. The two components are mixed only shortly before application, and then in general react without additional activation. However, catalysts can also be employed or higher temperatures used to accelerate the crosslinking reaction.

Suitable crosslinking agents (III) include blocked or unblocked polyisocyanate crosslinking agents, amide- and amine-formaldehyde resins, phenolic resins, aldehyde and ketone resins (such as phenol-formaldehyde resins), resols, furan resins, urea resins, carbamic acid ester resins, triazine resins, melamine resins, benzoguanamine resins, cyanamide resins and aniline resins, such as those described in “Lackkunstharze”, H. Wagner, H. F. Sarx, Carl Hanser Verlag Munich, 1971. Polyisocyanates are preferred.

Polyisocyanates having free isocyanate groups are especially preferred as crosslinking component (III), since the aqueous polyurethane coatings obtained display a particularly high level of coating properties. Suitable crosslinking agents (III) include 1-isocyanato-3,3,5-trimethyl-5-isocyanatomethyl-cyclo-hexane, hexamethylene-diisocyanate, 1,4-diisocyanatocyclohexane or bis-(4-isocyanatocyclohexane)-methane or 1,3-(bis-2-isocyanatoprop-2-yl)-benzene, or polyisocyanate adducts such as those prepared from hexamethylene-diisocyanate, 1-isocyanato-3,3,5-trimethyl-5-isocyanatomethyl-cyclohexane or bis-(4-iso-cyanatocyclohexane)-methane which contain uretdione, biuret, isocyanurate or iminooxadiazinedione groups, and polyisocyanate adducts which contain urethane groups and are prepared from 2,4- and/or 2,6-diisocyanatotoluene or 1-isocyanato-3,3,5-trimethyl-5-isocyanatomethyl-cyclohexane and low molecular weight polyhydroxy compounds, such as trimethylolpropane, the isomeric propanediols or butanediols or mixtures of such polyhydroxy compounds.

Two-component coating compositions can also be employed.

The compounds containing free isocyanate groups can optionally be converted by reaction with so-called blocking agents into less reactive derivatives, which then react only after activation, for example at higher temperatures. Suitable blocking agents for these polyisocyanates include monohydric alcohols, such as methanol, ethanol, butanol, hexanol, cyclohexanol and benzyl alcohol; oximes such as acetoxime, methyl ethyl ketoxime and cyclohexanone oxime; lactams such as ε-caprolactam; phenols; amines such as diisopropylamine or dibutylamine; dimethylpyrazole; triazole; malonic acid dimethyl ester, malonic acid diethyl ester or malonic acid dibutyl ester.

The use of low-viscosity, hydrophobic or hydrophilic polyisocyanates having free isocyanate groups based on aliphatic, cycloaliphatic, araliphatic and/or aromatic isocyanates, preferably aliphatic or cycloaliphatic isocyanates, is very particularly preferred, since a particularly high level of resistance of the coating can be achieved in this way. These polyisocyanates in general have a viscosity at 23° C. of 10 to 3,500 mPas.

If necessary, the polyisocyanates can be employed in admixture with small amounts of inert solvents in order to lower the viscosity to a value within the range mentioned. Triisocyanatononane can also be employed in component (III), by itself or in mixtures.

Components (I) and (II) are in general sufficiently hydrophilic, so that the dispersibility of even hydrophobic crosslinking agents as component (III) is ensured. If desired, however, additional external emulsifiers, which are known, can also be added. However, water-soluble or dispersible polyisocyanates, such as those modified to contain carboxylate, sulfonate and/or polyethylene oxide groups and/or polyethylene oxide/polypropylene oxide groups, can also be employed as component (III). The use of mixtures of various crosslinking agents of the abovementioned type in component (III) is also possible.

Polymers which are dispersible, emulsifiable or soluble in water and differ from the constituents of components (I) to (III) are suitable as the film-forming resins of component (IV). Examples of these are polyesters optionally containing epoxide groups, polyurethanes, acrylic polymers, vinyl polymers such as polyvinyl acetate, polyurethane dispersions, polyacrylate dispersions, polyurethane-polyacrylate hybrid dispersions, polyvinyl ether or polyvinyl ester dispersions and polystyrene or polyacrylonitrile dispersions. The solids content of the film-forming resins of component (IV) is preferably 10 to 100 wt. %, more preferably 30 to 100 wt. %.

PU polymers (I) and PU polymers (II) are dispersed in water and mixed with the crosslinking agent (III) and optionally with film-forming resins (IV).

It is also possible for PU polymers (II) to be in the form of a solution in a solvent which is water-miscible and inert towards isocyanate groups and to be transferred into the aqueous phase by introducing it into PU dispersion (I) and then mixed with the crosslinking agent (III) and optionally with the film-forming resins (IV).

The ratio of the crosslinking agent (II) to the compounds which are reactive with it of components (II) and optionally (IV) is chosen such that the equivalent ratio of groups from (II) and (IV) which are reactive towards the crosslinking agent (e.g. OH groups) to the reactive groups of the crosslinking agent (in the case of isocyanates, NCO groups) is 0.5:1.0 to 3.5:1.0, preferably 1.0:1.0 to 3.0:1.0 and more preferably 1.0:1.0 to 2.5:1.0.

The mixture of components (I), (II) and (IV) preferably contains 5 to 95 wt. %, particularly preferably 25 to 75 wt. % of component (II), where the amounts of (I) and (IV) are chosen such that the total amounts of (I), (II) and (IV) add up to 100 wt. %.

The coating compositions can contain conventional coating additives such as defoamers, thickeners, pigments, dispersing auxiliaries, matting agents, catalysts, skin prevention agents, antisettling agents and/or emulsifiers, as well as additives which intensify the desired soft feel effect. The time during the preparation of the coating compositions when the additives are incorporated is not critical.

Curing is conventionally carried out at temperatures between room temperature and 130° C. In this context, the two-component technology with non-blocked polyisocyanates as crosslinking agents allows the use of comparatively low curing temperatures in the abovementioned range.

The production of the coating on the carrier film can take place by the various spraying processes, such as, for example, the compressed air, airless or electrostatic spraying process, using one- or optionally two-component spraying equipment. However, the coating compositions can also be applied by other methods, for example by brushing, rolling, dipping or knife-coating.

In order to coat part regions on the film, e.g. screen printing is preferably employed. The layer thicknesses can be between 2 micrometres and 100 micrometres, preferably between 5 and 75 μm, and more preferably between 5 and 50 μm.

For the production of the composite films, conventional films of plastic, e.g. PET, polycarbonate, PMMA or polysulfone, can be employed as the carrier layer. The films can optionally be pretreated by processes such as corona treatment. The films preferably have thicknesses of between 2 and 2,000 micrometers. Carrier layers of polycarbonate and polycarbonate blends are preferably used. The carrier films can also be composite films of several layers of plastic.

All polycarbonates which are known or commercially obtainable are suitable as the carrier film. The polycarbonates which are suitable as the carrier film preferably have a molecular weight in the range from 10,000 to 60,000 g/mol. They are obtainable e.g. in accordance with the processes of DE-B-1 300 266 by interfacial polycondensation or in accordance with the process of DE-A-1 495 730 by reaction of diphenyl carbonate with bisphenols. The preferred bisphenol is 2,2-di(4-hydroxyphenyl)propane, generally referred to as bisphenol A.

Other suitable aromatic dihydroxy compounds can also be used, such as 2,2-di (4-hydroxyphenyl)pentane, 1,6-dihydroxynaphthalene, 4,4′-dihydroxydiphenyl-sulfane, 4,4′-dihydroxydiphenyl ether, 4,4′-dihydroxydiphenyl sulfone, 4,4′-dihydroxydiphenylmethane, 1,1-di(4-hydroxyphenyl)ethane, 4,4′-dihydroxy-diphenyl- or dihydroxydiphenylcycloalkanes, preferably dihydroxydiphenylcyclohexanes or dihydroxycyclopentanes, as well as mixtures of these dihydroxy compounds.

Polycarbonates, which are particularly suitable as the carrier film, are those which contain units derived from esters of resorcinol or alkylresorcinols, such as those described, for example, in WO 00/15718 or WO 00/26274. These polycarbonates are marketed, for example, by General Electric Company under the brand name Sollx®.

In addition to these carrier films, blends or mixtures of plastics can also be employed. Blends of polycarbonate and polyesters, e.g. polybutylene terephthalate or polyethylene terephthalate, and polyesters of cyclohexanedicarboxylic acid and cyclohexanedimethanol, have proved to be particularly advantageous. Such products are marketed under the names Bayfol® by Bayer MaterialScience AG or Xylex® by General Electric Company.

Copolycarbonates according to U.S. Pat. No. 3,737,409 can also be used. Copolycarbonates based on bisphenol A and di-(3,5-dimethyldihydroxyphenyl) sulfone, which are distinguished by a high heat distortion point, are of particular interest. It is also possible to employ mixtures of different polycarbonates.

Impact-resistant PMMA is a polymethyl methacrylate which has been given impact resistance by suitable additives and is preferably employed. Suitable impact-modified PMMA's are described, for example, by M. Stickler, T. Rhein in Ullmann's Encyclopedia of Industrial Chemistry vol. A 21, pages 473-486, VCH Publishers Weinheim, 1992, and H. Domininghaus, Die Kunststoffe und ihre Eigenschaften, VDI-Verlag Düsseldorf, 1992.

All the known processes, for example by adapter or co-extrusion or laminating of layers on one another, are suitable for the production of the carrier film. The carrier film can also be cast from solution.

The surface of the carrier film can be shiny, structured or matted.

Suitable back-injecting, back-casting or back-pressing plastics include all the known thermoplastic polymeric materials. Suitable materials include thermoplastic polymers, such as polyolefins, e.g. polyethylene or polypropylene; polyesters, e.g. polybutylene terephthalate (PBT) and polyethylene terephthalate (PET); polycycloolefins; poly(meth)acrylates; polyamides; polycarbonates; polyurethanes; polyacetals, e.g. polyoxymethylene (POM); polystyrenes; polyphenylene ethers; polysulfones; polyether sulfones; polyether ketones; styrene (co)polymers; or mixtures of these polymers.

Particularly suitable polycarbonates are bisphenol A and TMC-bisphenol polycarbonates. Preferred polymer mixtures comprise polycarbonate and polybutylene terephthalate or polycarbonate and ABS polymer.

Because of the very good forming properties and the good adhesion as well as the good stretching properties of the soft touch layer in the composite film, not only level-shaped, i.e. substantially flat, or shell-shaped moldings, but also those having indentations and shapings, including perpendicular shapings or depressions (such as mobile phone keypads) can be produced. The good surface properties accompanying the composite films are also accessible in the case of composite moldings having a demanding geometry.

The composite moldings according to the invention are used in telecommunications equipment and in vehicle, ship and aircraft construction.

The invention is to be explained in more detail with the aid of the following examples.

### EXAMPLES

Films Employed:

Bayfol® CR 6-2: 375 μm thick extruded film from Bayer MaterialScience AG made from a polycarbonate blend

Materials Employed for the Soft Touch Coating:

Component 1:

Bayhydrol® PR 240:

Aliphatic, anionic hydrophilic PU dispersion free from hydroxyl groups and having a solids content of 40% and an average particle size of 100-300 nm from Bayer MaterialScience AG, Leverkusen, Del.

Bayhydrol® XP 2419:

Aliphatic, anionic hydrophilic PU dispersion free from hydroxyl groups and having a solids content of 50% from Bayer MaterialScience AG, Leverkusen, Del.

Component II:

Bayhydrol® XP 2429:

Aliphatic, hydroxy-functional polyester-polyurethane dispersion having a solids content of 55%, OH content approx. 0.8% from Bayer MaterialScience AG, Leverkusen, Del.

Bayhydrol® VP LS 2058:

Aqueous, hydroxy-functional polyacrylate dispersion having a solids content of approx. 42%, OH content approx. 2% from Bayer MaterialScience AG, Leverkusen, Del.

Bayhydrol® A 145:

Water-dilutable, OH-functional polyacrylate dispersion having a solids content of approx. 45%, OH content, based on the solid resin, approx. 3.3% from Bayer MaterialScience AG, Leverkusen, Del.

Bayhydrol® PT 241:

Hydroxy-functional polyester-polyurethane dispersion having a solids content of approx. 41%, OH content, based on the solid resin, approx. 2.5% from Bayer MaterialScience AG, Leverkusen, Del.

Component III:

Bayhydur® 3100:

Hydrophilic, aliphatic polyisocyanate based on hexamethylene-diisocyanate (HDI) having an isocyanate content of 17.4% from Bayer MaterialScience AG, Leverkusen, Del.

Additives:

| | |
|---|---|
| BYK 348: | wetting agent (BYK-Chemie, Wesel, DE) |
| Tego-Wet KL | flow additive, 50% strength in water (Tegochemie, |
| 245: | Essen, DE) |
| Aquacer 535: | wax emulsion (BYK-Chemie, Wesel, DE) |
| Defoamer DNE: | defoamer (K. Obermeyer, Bad Berleburg, DE) |
| Sillitin Z 86: | filler (Hoffmann & Söhne, Neuburg, DE) |
| Pergopak M 3: | filler, matting agent (Martinswerk, Bergheim, DE) |
| Talcum IT extra: | matting agent (Norwegian Talc, Frankfurt, DE) |
| Bayferrox ® | colored pigment (black) (Bayer AG, Leverkusen, DE) |
| OK 412: | matting agent (Degussa, Frankfurt, DE) |
| MPA: | 1-methoxy-2-propyl acetate |

TABLE 1
Coating compositions employed in Examples 1 to 6 (Example 1
and 2: soft touch coatings according to the invention, Examples 3
to 6: comparison examples); clear coating compositions

| Example | | | | | |
|---|---|---|---|---|---|
| 1 | 2 | 3 | 4 | 5 | 6 |

Component I:

| | | | | | | |
|---|---|---|---|---|---|---|
| Bayhydrol ® PR 240 | 38.2 | — | — | — | — | — |
| Bayhydrol ® XP 2419 | — | 33.5 | — | — | — | — |

Component II:

| | | | | | | |
|---|---|---|---|---|---|---|
| Bayhydrol ® XP 2429 | 28.2 | 30.6 | 53.8 | — | — | — |
| Bayhydrol ® VP LS 2058 | — | — | — | 46.6 | — | — |
| Bayhydrol ® A 145 | — | — | — | — | 51.3 | — |
| Bayhydrol ® PT 241 | — | — | — | — | — | 58.1 |
| Water, demineralized | 14.2 | 15.3 | 19.5 | 12.2 | 13.0 | 11.4 |
| Defoamer DNE | 0.2 | 0.2 | 0.2 | 0.2 | 0.2 | 0.2 |
| Byk 348 | 0.5 | 0.6 | 0.6 | 0.6 | 0.6 | 0.6 |
| Tegowet KL 245 | 0.3 | 0.4 | 0.4 | 0.4 | 0.4 | 0.4 |
| Aquacer 535 | 1.4 | 1.5 | 1.7 | 1.7 | 1.6 | 1.6 |
| Sillitin Z 86 | 3.3 | 3.6 | 3.9 | 3.9 | 3.7 | 3.6 |
| Pergopak M3 | 5.0 | 5.4 | 5.8 | 5.9 | 5.5 | 5.5 |
| OK 412 | 1.7 | 1.8 | 1.9 | 2.0 | 1.8 | 1.8 |

Component III:

| | | | | | | |
|---|---|---|---|---|---|---|
| Curing agent: Bayhydur ® | 6.4 | 6.9 | 12.2 | 26.5 | 21.9 | 16.8 |
| 3100 75% MPA | | | | | | |
| Total | 100.0 | 100.0 | 100.0 | 100.0 | 100.0 | 100.0 |
| NCO/OH ratio | 1.5 | 1.5 | 1.5 | 1.5 | 1.5 | 1.5 |
| Solids content | ˜50 | ˜50 | ˜50 | ˜50 | ˜50 | ˜50 |

| | |
|---|---|
| Application parameters | Air pressure: 3 bar; nozzle size: 1.4; |
| | Drying: 10′ RT + 30′ 80° C. + 16 h 60° C. |

All the amounts stated are in per cent by weight.

The stock coating composition (components (I) and (II) and the additives) was prepared, after predispersing, by grinding via a laboratory shaker. The temperature of the dispersion did exceed 40° C. OK 412 was than stirred in for approx. 10 min. After the crosslinking, the coating system was adjusted to a flow time of approx. 30 s (addition of water; DIN ISO 2431, 5 mm nozzle), sprayed conventionally in one layer on to the rough side of the film Bayfol® CR 6-2 and dried under the following drying conditions: evaporation in air at RT for 10 min, 30 min at 80° C. and 16 h at 60° C. (aging).

The coating layer thickness was between 30 and 40 μm.

The films coated with coating were then tested for various properties. The results are shown in the following Tables 2 and 3.

TABLE 2
Test results of the Bayfol ® CR 6-2 films coated with coatings 1-6

| | | | Resistance to | |
|---|---|---|---|---|
| | | | solvents | Crockmeter |
| | Visual | | (1 min static)³ | test⁴ |
| | impression | | in | −/+ ethanol |
| | and haptic | Gloss | EtAc/MPA/X | strokes, |
| Example | properties¹ | 60°² | EtOH/SP/H₂O | dynamic |
| 1 (inv.) | flawless 1 | 3.2 | 4/2/1 | >100/20 |
| | | | 2/1/0 | |
| 2 (inv.) | flawless 2 | 3.2 | 4/2/1 | >100/15 |
| | | | 2/1/0 | |
| 3 (comp.) | flawless | 1.2 | 4/2/1 | >100/20 |
| | 2-3 | | 2/1/0 | |
| 4 (comp.) | Flawless 5 | 1.3 | 1/1/1 | >100/20 |
| | | | 0/1/0 | |
| 5 (comp.) | flawless 5 | 2.6 | 1/1/1 | >100/100 |
| | | | 0/1/0 | |
| 6 (comp.) | flawless 5 | 0.9 | 1/1/1 | >100/20 |
| | | | 0/1/0 | |

EtAc = ethyl acetate,
MPA = 1-methoxy-2-propyl acetate,
X = xylene,
EtOH = ethanol,
SP = super-grade petrol

Thermoformability by Means of High Pressure Forming

The Bayfol® 6-2 films coated according to Examples 1 to 6 were shaped in accordance with DE-A 38 40 542. The experiments were carried out on a high pressure forming installation from HDVF Kunststoffmaschinen GmbH, model SAMK 360. A heating-ventilation diaphragm was used as the forming mold for the back-injection experiments. The forming parameters were chosen as follows: heating rate 13 sec, heating field setting 240° C.-280° C., mold temperature 100° C., forming pressure 120 bar. The formed films were stamped out according to shape. The adhesion, the cracking and white discoloration of the coatings after the forming were evaluated visually.

TABLE 3
Test results of the Bayfol ® CR 6-2 films coated with coatings 1-6

| | | Thermoforming |
|---|---|---|
| | | properties⁶ at 12 s heating |
| | Pendulum hardness⁵ | rate |
| Example | [s] | mold: 2 diaphragms |
| 1 (inv.) | 43 | 0-1 |
| 2 (inv.) | 28 | 0-1 |
| 3 (comp.) | 48 | 3 |
| 4 (comp.) | 39 | 5 |
| 5 (comp.) | 74 | 5 |
| 6 (comp.) | 20 | 5 |

¹Haptic properties; numerical value: 0 (very good), 1 (good), 2 (satisfactory), 3 and 4 (no longer adequate), 5 (poor)
²Gloss
³Contact with a cottonwool pad (1 min at RT): 0 (no damage)-5 (coating destroyed)
⁴Crockmeter Atlas CM6: number of strokes until a discoloration of the linen cloth used is visible; − = dry cloth, + = cloth soaked with ethanol
⁵König pendulum hardness in accordance with DIN EN ISO 1522
⁶Numerical value: 0 (very good), 1 (good), 2 (satisfactory), 3 and 4 (no longer adequate), 5 (poor)
0 (no cracking)
1 (slight cracking)
2 (cracking)
3 (more severe cracking)
4 (severe cracking)
5 (very severe cracking over most of the area)

The results listed in Tables 2 and 3 demonstrate that very good thermoformabilities of the coated film can be obtained only with the soft touch clear coatings employed according to the invention (Examples 1 and 2).

Table 4: Coating Compositions Employed in Examples 7 to 12 (Example 7 and 8: Soft Touch Coatings According to the Invention, Examples 9 to 12: Comparison Examples); Pigmented One-Layer Top Coating Systems (Black)

TABLE 4

| Example | | | | | |
|---|---|---|---|---|---|
| 7 | 8 | 9 | 10 | 11 | 12 |

Component I:

| | | | | | | |
|---|---|---|---|---|---|---|
| Bayhydrol ® PR 240 | 28.3 | — | — | — | — | — |
| Bayhydrol ® XP 2419 | — | 27.5 | — | — | — | — |

Component II:

| | | | | | | |
|---|---|---|---|---|---|---|
| Bayhydrol ® XP 2429 | 20.6 | 25.0 | 37.8 | — | — | — |
| Bayhydrol ® VP LS 2058 | — | — | — | 33.3 | — | — |
| Bayhydrol ® VP A 145 | — | — | — | — | 38.8 | — |
| Bayhydrol ® PT 241 | — | — | — | — | — | 45.0 |
| Water, demineralised | 26.5 | 17.5 | 31.0 | 24.6 | 21.6 | 18.8 |
| Defoamer DNE | 0.2 | 0.2 | 0.2 | 0.2 | 0.2 | 0.2 |
| Byk 348 | 0.4 | 0.5 | 0.4 | 0.4 | 0.4 | 0.4 |
| Tegowet KL 245 | 0.3 | 0.3 | 0.3 | 0.3 | 0.3 | 0.3 |
| Aquacer 535 | 1.0 | 1.3 | 1.2 | 1.2 | 1.2 | 1.2 |
| Sillitin Z 86 | 2.4 | 2.9 | 2.7 | 2.8 | 2.8 | 2.8 |
| Pergopak M3 | 3.6 | 4.4 | 4.1 | 4.2 | 4.2 | 4.2 |
| Talc IT extra | 1.2 | 1.5 | 1.4 | 1.4 | 1.4 | 1.4 |
| Bayferrox ® 318 M | 9.6 | 11.7 | 10.9 | 11.3 | 11.2 | 11.3 |
| OK 412 | 1.2 | 1.5 | 1.4 | 1.4 | 1.4 | 1.4 |

Component III:

| | | | | | | |
|---|---|---|---|---|---|---|
| Curing agent: Bayhydur ® | 4.7 | 5.7 | 8.6 | 18.9 | 16.5 | 13.0 |
| 3100 75% MPA | | | | | | |
| Total | 100.0 | 100.0 | 100.0 | 100.0 | 100.0 | 100.0 |
| NCO/OH ratio | 1.5 | 1.5 | 1.5 | 1.5 | 1.5 | 1.5 |
| Solids content | ˜55 | ˜55 | ˜55 | ˜55 | ˜55 | ˜55 |

| | |
|---|---|
| Application | Air pressure: 3 bar; nozzle size: 1.4; |
| | Drying: 10′ RT + 30′ 80° C. + 16 h 60° C. |

All the amounts stated are in per cent by weight.

The stock coating composition was prepared, after predispersing, by grinding via a laboratory shaker. The temperature of the dispersion did not exceed 40° C. OK 412 was then stirred in for approx. 10 min. After the crosslinking, the coating system was adjusted to a flow time of approx. 30 s by addition of water (DIN ISO 2431, 5 mm nozzle), sprayed conventionally in one layer on to the rough side of the film Bayfol® CR 6-2 and dried under the following drying conditions: evaporation in air at RT for 10 min, 30 min at 80° C. and 16 h at 60° C. (ageing).

The coating layer thickness was between 30 and 40 μm.

The films coated with coating were then tested for various properties. The results are shown in the following Tables 5 and 6.

TABLE 5
Test results of the Bayfol ® CR 6-2 films coated with coatings 7-12

| | | | Resistance to | |
|---|---|---|---|---|
| | | | solvents | Crockmeter |
| | Visual | | (1 min static)³ | test⁴ |
| | impression | | in | −/+ ethanol |
| | and haptic | | EtAc/MPA/X | strokes, |
| Example | properties¹ | Gloss 60°² | EtOH/SP/H₂O | dynamic |
| 7 (inv.) | slightly | 1.6 | 5/4/5 | >100/20 |
| | perforated 1 | | 2/4/0 | |
| 8 (inv.) | slightly | 1.7 | 4/4/4 | >100/10 |
| | perforated 2 | | 3/3/0 | |
| 9 (comp.) | slightly | 0.5 | 4/3/3 | >100/15 |
| | perforated | | 2/2/0 | |
| | 2-3 | | | |
| 10 (comp.) | flawless 5 | 0.6 | 1/0/1 | 80/10 |
| | | | 1/1/0 | |
| 11 (comp.) | flawless 5 | 0.7 | 1/0/0 | 50/80 |
| | | | 1/0/0 | |
| 12 (comp.) | flawless 5 | 0.3 | 2/0/0 | >100/15 |
| | | | 1/1/0 | |

Thermoformability by Means of High Pressure Forming

The Bayfol® 6-2 films coated according to Examples 7 to 12 were formed in accordance with DE-A 38 40 542. The experiments were carried out on a high pressure forming installation from HDVF Kunststoffmaschinen GmbH, model SAMK 360. A heating-ventilation diaphragm was used as the forming mold for the back-injection experiments. The forming parameters were chosen as follows: heating rate 13 sec, heating field setting 240° C.-280° C., mold temperature 100° C., forming pressure 120 bar. The formed films were stamped out according to shape. The adhesion, the cracking and white discoloration of the coatings after the forming were evaluated visually.

TABLE 6
Test results of the Bayfol ® CR 6-2 films coated with coatings 7-12

| | | Thermoforming |
|---|---|---|
| | | properties⁶ at 12 s heating |
| | Pendulum hardness⁵ | rate |
| Example | [s] | mold: 2 diaphragms |
| 7 (inv.) | 45 | 0-1 |
| 8 (inv.) | 29 | 1 |
| 9 (comp.) | 42 | 3 |
| 10 (comp.) | 45 | 5 |
| 11 (comp.) | 73 | 5 |
| 12 (comp.) | 22 | 4 |

The results listed in Tables 5 and 6 demonstrate that very good thermoformabilities of the coated film can be obtained only with the specific pigmented soft touch coatings according to the invention (Examples 7 and 8).

### Example 13

### Application by Means of Screen Printing

The stock coating composition corresponding to experiments 1 to 12 was prepared, after predispersing, by grinding via a laboratory shaker. The temperature of the dispersion did not exceed 40° C. OK 412 was then stirred in for approx. 10 min. After the crosslinking with Bayhydur® 3100, the coating system was mixed with Borchigel I 75 (25% in water; thickener from Borchers) by means of a glass rod. Thereafter, it was printed on to the rough side of Bayfol® CR by means of screen printing and the film was stored at room temperature for 10 minutes. The film was then dried at 65° C. in a tunnel dryer at 2 m/min.

The coating layer thickness was approx. 10 μm.

Evaluation: The films printed with the soft touch coatings of Examples 1, 2, 7 and 8 had a pleasant handle and could be formed under pressure (HPF) without white fracture and cracking.

### Example 14

### Suitability for Back-Injecting

The stamped-out, formed and coated films were laid in the opened injection mold such that the side of the formed film from Examples 1 to 12 coated with soft touch coating lay opposite the injection point of the thermoplastic. The film was fixed in the mold by electrostatic charging. After the mold was closed, bisphenol A polycarbonate having a rel. viscosity of 1.3 (measured in methylene chloride at 20° C. and a concentration of 0.5 g/100 cl) was injected in. The total thickness of the finished component was 6 mm.

Evaluation: After the back-injection, the composite moldings coated with the soft touch coating showed no shiny areas. The regions of the back-injected composite film formed with small radii also showed homogeneous matting over the entire area and had a pleasant handle.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composite plastic molding comprising
A) a thermoplastically formable, heat-resistant composite film comprising
A1) a carrier film of a thermoplastic resin and
A2) a coating of a soft touch coating on one side of the carrier film (A1), and
B) a thermoplastic layer on the side of the carrier film (A1) facing away from the soft touch coating,
wherein the soft touch coating (A2) is obtained from a composition comprising
i) a polyurethane and/or a polyurethane-urea which is free from hydroxyl and/or amine groups,
ii) an ionically modified polyurethane and/or polyurethane-urea which contains hydroxyl and/or amine groups,
iii) at least one crosslinking agent,
iv) optionally a film-forming resin and
v) optionally an additive.

2. A process for the production of the composite plastic molding of claim 1 which comprises
I) introducing a thermoplastically formable, heat-resistant composite film (A) of a carrier film (A1) of a thermoplastic resin and a coating (A2) of a soft touch coating on one side of the carrier film (A1) into a mold and
II) back-injecting, back-pressing, back-casting or back-foaming composite film A) with a thermoplastic resin on the side facing away from the soft touch coating,
wherein the soft touch coating is obtained from a composition comprising
i) a polyurethane and/or polyurethane-urea which is free from hydroxyl and/or amine groups,
ii) an ionically modified polyurethane and/or polyurethane-urea which contains hydroxyl and/or amine groups,
iii) at least one crosslinking agent,
iv) optionally a film-forming resin and
v) optionally an additive.

3. Telecommunications equipment, a motor vehicle, a ship or an aircraft containing the composite plastic molding of claim 1.
